(19) United States
(12) Patent Application Publication
(10) Pub. No.: US 2018/0180191 A1
(43) Pub. Date: Jun. 28, 2018

(54) INTEGRATED CHECK-RELIEF VALVE

(71) Applicant: BorgWarner Inc., Aubum Hills, MI (US)

(72) Inventor: Toru Shinoyama, Nabari, Mie (JP)

(21) Appl. No.: 15/738,619

(22) PCT Filed: Jun. 20, 2016
(86) PCT No.: PCT/US2016/038306

§ 371 Date: Dec. 21, 2017

(30) Foreign Application Priority Data
Jun. 27, 2015 (JP) 2015-129341

(51) Int. Cl. F16K 17/196; F16H 7/08

(52) U.S. Cl. CPC F16K 17/196; F16H 2007/0859; F16H 2007/0814; F16H 7/0848

(57) ABSTRACT

Provided is an integrated check-relief valve in which a retreat amount of a valve seat member can be regulated when a relief valve is in operation. There is provided an integrated check-relief valve (1) including a tubular valve housing 2 ( ) of which both ends are open. Inside the valve housing (2), a check ball (3) and a valve disk (4) with which the check ball (3) can come into contact are provided so as to be movable in an axial direction, a check spring (5) which urges the check ball (3) to the valve disk (4) side and a relief spring (6) which urges the valve disk (4) to the check ball 3 ( ) side are provided. A step portion (20) which is a regulation portion regulating a movement amount of the valve disk (4) with respect to a side where the relief spring (6) contracts is provided on an inner circumferential surface 2b of the valve housing (2).

### TECHNICAL FIELD

The present invention relates to an integrated check-relief valve, and specifically relates to an improvement of a structure thereof.

### BACKGROUND ART

JP-A-10-306857 discloses a tensioner provided with a check valve which has a function of a relief valve. The check valve has a valve housing, a valve member that is embedded on the inside thereof in a movable manner, a first valve seat member in which the valve member is seated, a second valve seat member that is fixed to the inside of the valve housing, a check spring that urges the valve member to the first valve seat member side, and a relief spring that urges the first valve seat member to the second valve seat member side (refer to Paragraphs [0060] to [0066] and FIGS. 1 to 3, 5, and 6 in JP-A-10-306857).

In the tensioner disclosed in PTL 1, when a plunger moves outward and pressure inside a chamber becomes lower than a predetermined minimum value during an operation, as the valve member moves to a side of being separate from the first valve seat member counteracting the spring force of the check spring, the check valve is opened. Accordingly, a fluid flows into the chamber from an external pressurized fluid source via a fluid introduction hole of a tensioner housing passing through the check valve (refer to Paragraph [0072] and FIG. 5 in JP-A-10-306857).

Meanwhile, when the plunger moves inward and the pressure inside the chamber becomes higher than a predetermined maximum value during an operation, as the first valve seat member moves to a side of being separate from the second valve seat member counteracting the spring force of the relief spring, the relief valve is opened. Accordingly, a high pressure fluid inside the chamber flows out through the relief valve via the fluid introduction hole of the tensioner housing (refer to Paragraph [0078] and FIG. 6 in JP-A-10-306857).

In the tensioner having the above-described configuration, in a case where the pressure inside the chamber becomes excessive during an operation, a movement amount (retreat amount) of the first valve seat member becomes excessive. As a result thereof, the first valve seat member inclines inside the valve housing, thereby causing a possibility that the first valve seat member becomes stuck inside the valve housing. In addition, when the movement amount of the first valve seat member (retreat amount) becomes excessive, the movement amount of the valve member which moves together with the first valve seat member also becomes excessive. As a result thereof, there is a possibility that the check spring urging the valve member exceeds a contraction state and is in a free length state so that the urging force counteracted by the valve member is not present.

### SUMMARY OF INVENTION

### Technical Problem

The present invention has been made in consideration of the circumstances in the related art. An object to be achieved by the present invention is to provide an integrated check-relief valve which can regulate a retreat amount of a valve seat member when a relief valve is in operation. In addition, the present invention realizes such an integrated check-relief valve in a simple structure.

### Solution to Problem

In order to achieve the above-described object, according to the present invention, there is provided an integrated check-relief valve including a tubular valve housing of which both ends are open. Inside the valve housing, a valve member and a valve seat member with which the valve member can come into contact are provided so as to be movable in an axial direction, a check spring which urges the valve member to the valve seat member side and a relief spring which urges the valve seat member to the valve member side are provided, and a regulation portion which regulates a movement amount of the valve seat member with respect to a side where the relief spring contracts is provided on an inner wall surface of the valve housing so as to extend in a direction of projecting radially inward from the inner wall surface (refer to claim 1).

According to the present invention, when the check valve is opened during an operation, as the valve member moves to a side of being separate from the valve seat member counteracting the spring force of the check spring, a gap is formed between the valve member and the valve seat member, and thus, the check valve is opened. Meanwhile, when the relief valve is opened during an operation, as the valve seat member moves to a side where the relief spring contracts counteracting the spring force of the relief spring, a gap is formed on the periphery of the valve seat member, and thus, the relief valve is opened.

In addition, in a case where the movement amount of the valve seat member becomes significant, the regulation portion provided on the inner wall surface of the valve housing regulates the movement amount of the valve seat member (retreat amount). Accordingly, when the relief valve is in operation, before the retreat amount of the valve seat member becomes excessive, the retreat of the valve seat member can be regulated. Therefore, it is possible to reliably prevent a possibility that the valve seat member inclines inside the valve housing and becomes stuck, and the check spring exceeds the contraction state and is in a free length state. Moreover, in this case, the regulation portion is provided on the inner wall surface so as to extend from the inner wall surface of the valve housing in a direction of projecting radially inward. Therefore, it is possible to realize the integrated check-relief valve in a simple structure in which the retreat amount of the valve seat member can be regulated.

In the present invention, the regulation portion is a step portion having a small diameter formed on the inner wall surface of the valve housing (refer to claim 2). In this case, the retreat amount of the valve seat member can be regulated in an extremely simple structure without adopting a separate member.

In the present invention, the regulation portion is a stopper ring which is held on the inner wall surface of the valve housing (refer to claim 3). In this case, a commercially available stopper ring can be used. Therefore, it is possible to reduce costs and to easily perform replacement at the time of maintenance.

In the present invention, the valve member is a check ball (refer to claim 4).

In the present invention, one or a plurality of flow channels are formed on an outer circumferential surface of the valve seat member (refer to claim 5). In this case, when the relief valve is in operation, the fluid passes through the relief valve via not only the gap on the periphery of the valve seat member but also the flow channels thereof. Therefore, it is possible to cause the fluid to smoothly move and to adjust the quantity of the moving fluid by the flow channel.

In the present invention, the flow channels are provided in at least two positions radially facing each other on the outer circumferential surface of the valve seat member (refer to claim 6).

In the present invention, a flange portion which protrudes radially inward from the inner wall surface of the valve housing and has an open hole at a center is integrally formed with the valve housing in an opening portion of the valve housing on one end side, and one end of the relief spring comes into contact with the flange portion (refer to claim 7).

In the present invention, a retainer which accommodates the valve member and the check spring is press-fitted in the opening portion of the valve housing on the other end side, and the valve seat member which is urged by the relief spring can come into contact with the retainer (refer to claim 8).

A liquid pressure tensioner according to the present invention includes the integrated check-relief valve that is disclosed in claim 1 (refer to claim 9).

In the present invention, a tensioner housing that has a hole which is open in at least one end, a plunger that is slidably accommodated in the hole and defines a chamber with respect to the hole, and a plunger spring that is provided in the hole and urges the plunger in a direction of projecting from the hole are included. The integrated check-relief valve is provided inside the chamber, and an opening portion of a valve housing on one end side communicates with a fluid introduction hole which is provided in the tensioner housing (refer to claim 10).

In the present invention, when the plunger is lengthened, if pressure of a fluid inside the chamber becomes lower than predetermined minimum pressure, the valve member moves to a side where the check spring contracts so as to form a gap between the valve member and the valve seat member, and the fluid inside the valve housing is introduced to the inside of the chamber through the gap. In addition, when the plunger contracts, if the pressure of the fluid inside the chamber exceeds predetermined maximum pressure, the valve seat member moves to the side where the relief spring contracts so as to form a gap on the periphery of the valve seat member and the fluid inside the chamber flows into the valve housing through the gap and flows out from the opening portion of the valve housing on the one end side, and if the pressure of the fluid inside the chamber becomes higher, additional movement of the valve seat member is regulated by the regulation portion (refer to claim 11).

### Advantageous Effects of Invention

As described above, according to an integrated check-relief valve of the present invention, a regulation portion which regulates a movement amount of a valve seat member with respect to a side where a relief spring contracts is provided on an inner wall surface of a valve housing so as to extend from the inner wall surface in a direction of projecting radially inward. Therefore, in a case where the movement amount of the valve seat member becomes significant when a relief valve is opened, the movement amount of the valve seat member (retreat amount) can be regulated by the regulation portion. Accordingly, before the retreat amount of the valve seat member becomes excessive, the retreat of the valve seat member can be regulated. Therefore, it is possible to reliably prevent a possibility that the valve seat member inclines inside the valve housing and becomes stuck and a possibility that a check spring exceeds the contraction state and is in a free length state. Moreover, the regulation portion is provided on the inner wall surface so as to extend in a direction of projecting radially inward from the inner wall surface of the valve housing. Therefore, it is possible to realize the integrated check-relief valve in a simple structure in which a retreat amount of the valve seat member can be regulated.

### BRIEF DESCRIPTION OF DRAWINGS

FIG. 1 is a schematic diagram of a longitudinal sectional view of a chain tensioner which includes an integrated check-relief valve of an exemplary embodiment of the present invention in which a plunger is in a maximum contraction state.

FIG. 2 is a longitudinal sectional view illustrating a configuration of the integrated check-relief valve (FIG. 1).

FIG. 3 is a partially enlarged view of the integrated check-relief valve (FIG. 2).

FIG. 4 is a bottom view of a retainer configuring the integrated check-relief valve (FIG. 2).

FIG. 5 is a bottom view of a valve seat member configuring the integrated check-relief valve (FIG. 2).

FIG. 6 is a diagram for describing a state of the integrated check-relief valve (FIG. 3) when a check valve is opened.

FIG. 7 is a diagram for describing a state of the integrated check-relief valve (FIG. 3) when a relief valve is opened.

FIG. 8 is a diagram for describing a function of a regulation portion when the relief valve of the integrated check-relief valve (FIG. 3) is opened.

FIG. 9 is a longitudinal sectional view illustrating a configuration of the integrated check-relief valve in a modification example of the present invention.

FIG. 10 is a partially enlarged view of the integrated check-relief valve (FIG. 9).

FIG. 11 is a diagram for describing a function of the regulation portion when the relief valve of the integrated check-relief valve (FIG. 10) is opened.

### DESCRIPTION OF EMBODIMENTS

Hereinafter, an exemplary embodiment of the present invention will be described with reference to the accompanying drawings.

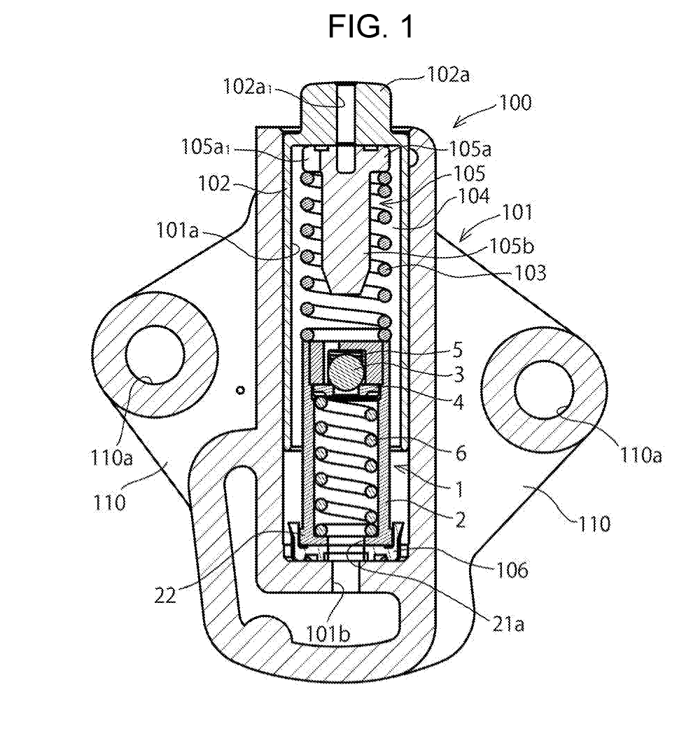

FIGS. 1 to 8 are diagrams for describing an integrated check-relief valve (hereinafter, will be simply referred to as the “check-relief valve”) of the exemplary embodiment of the present invention. Here, an example in which the check-relief valve is applied to a liquid pressure tensioner is illustrated. In the description below, for convenience of description, in each of longitudinal sectional views of the liquid pressure tensioner and the check-relief valve in which a distal end of a plunger is illustrated as being oriented upward, the upward direction (upper side) and the downward direction (lower side) in each diagram are respectively referred to as the upward direction (upper side) and the downward direction (lower side, bottom side, and bottom surface side) of the liquid pressure tensioner and the check-relief valve.

As illustrated in FIG. 1, a liquid pressure tensioner 100 includes a tensioner housing 101 that has a hole 101a which is open in one end, a hollow plunger 102 which is slidably accommodated inside the hole 101a, a plunger spring 103 which is arranged inside the hole 101a and urges the plunger 102 in a direction of projecting from the hole 101a, and a check-relief valve 1 which is provided in the bottom portion of the hole 101a. For example, a distal end portion 102a of the plunger 102 comes into contact with a chain (not illustrated), thereby being used so as to apply tensile force to the chain. A fluid introduction hole 102a₁ is formed in the distal end portion 102a. FIG. 1 illustrates a state where the plunger 102 maximally contracts (that is, the plunger 102 moves in a retreating direction).

On the bottom wall of the hole 101a of the tensioner housing 101, a fluid introduction hole (oil supply hole) 101b is formed in a penetrating manner, and a fluid supplied from an external pressurized fluid source (not illustrated) is introduced through the fluid introduction hole (oil supply hole) 101b. The internal space of the plunger 102 and the hole 101a define a chamber 104 which accumulates the fluid, and the fluid introduction hole 101b communicates with the chamber 104. Inside the chamber 104, a vent disk 105 for discharging air which is incorporated into the chamber 104, through the fluid introduction hole 102a₁ in the distal end portion 102a of the plunger 102 together with the fluid is disposed. The vent disk 105 has a head portion 105a which has a large diameter and in which a flow channel 105a₁ is formed, and a shaft portion 105b which has a small diameter and extends downward from a lower surface of the head portion 105a. A top surface of the head portion 105a comes into contact with an inner wall surface of the distal end portion 102a of the plunger 102, and the upper end of the plunger spring 103 comes into contact with the lower surface of the head portion 105a. The shaft portion 105b is inserted into the inner space of the plunger spring 103. In addition, the tensioner housing 101 has a flange 110 which protrudes outward. In the flange 110, a screw insertion hole 110a is formed in a penetrating manner, and an attachment screw for attaching the liquid pressure tensioner 100 to an external installation wall (for example, an engine block and the like) is inserted into the screw insertion hole 110a.

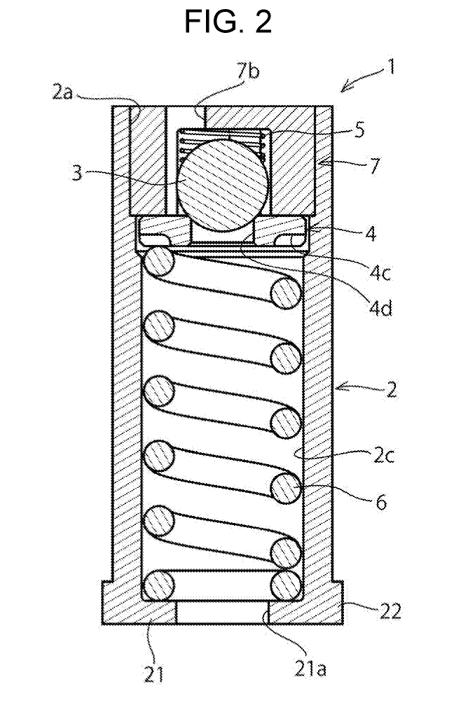

As illustrated in FIG. 2, the check-relief valve 1 has a cylindrical valve housing 2 of which both upper and lower ends are open. Inside the valve housing 2, a check ball (valve member) 3 which is configured to be a solid ball, and a valve disk (valve seat member) 4 with which the check ball 3 comes into contact so as to be seated are provided in a movable manner in an axial direction. In addition, inside the valve housing 2, a check spring 5 which urges the check ball 3 to the valve disk 4 side, and a relief spring 6 which urges the valve disk 4 to the check ball 3 side are provided.

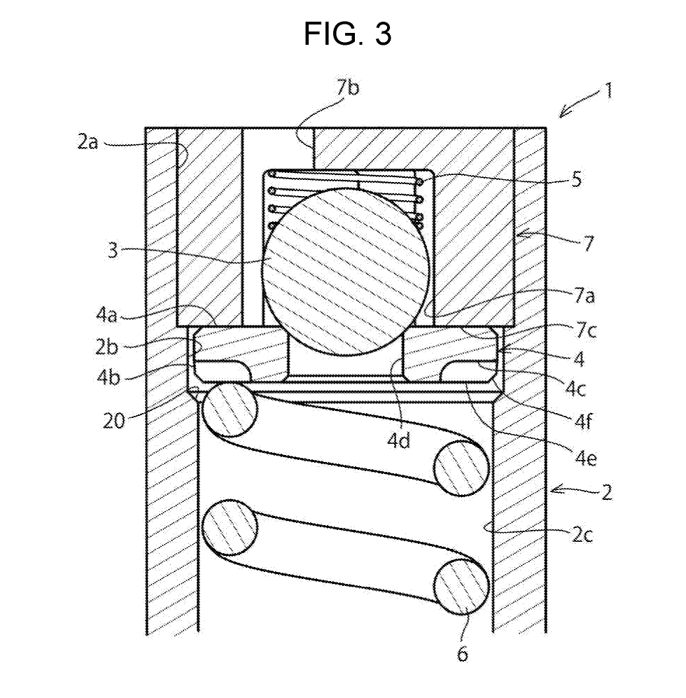

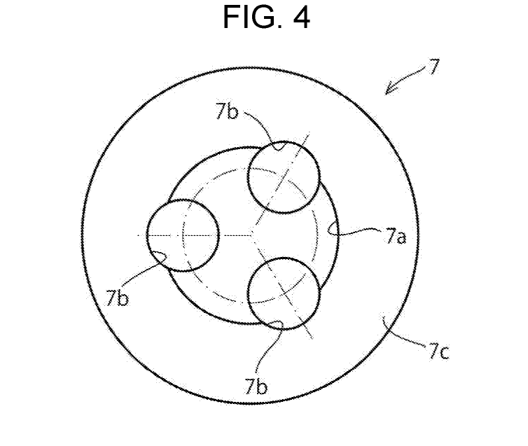

In an upper side opening portion 2a of the valve housing 2, a substantially cylindrical retainer 7 is fixedly attached by performing press-fitting or the like. In the retainer 7, as illustrated in FIGS. 3 and 4, on the bottom surface side thereof, a blind hole 7a which is disposed at the center, and three penetration holes 7b which partially overlaps the blind hole 7a and are disposed at equal intervals on the circumference are formed. The check ball 3 and the check spring 5 are accommodated inside the blind hole 7a of the retainer 7. Each of the penetration holes 7b communicates with the chamber 104 of the liquid pressure tensioner 100 (refer to FIG. 1). A top surface 4a of the valve disk 4 comes into contact with a lower surface 7c of the retainer 7, and the lower surface 7c of the retainer 7 functions as a sheet surface of the valve disk 4. As the valve housing 2, a cylindrical member which extends substantially straight in the axial direction is adopted, and the retainer 7 is press-fitted to the upper side opening portion 2a of the valve housing 2 from behind. Therefore, each of components accommodated inside the valve housing 2 can be introduced to the inside of the valve housing 2 from the upper side opening portion 2a of the valve housing 2.

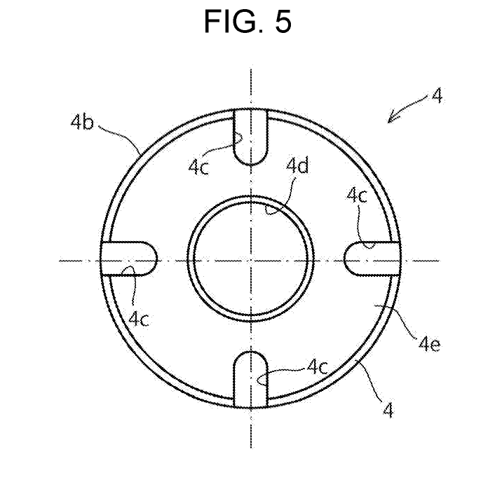

As illustrated in FIGS. 3 and 5, the valve disk 4 is a substantially disk-shaped member, and an outer circumferential surface 4b is designed to have a size so as to have a minute gap with respect to an inner circumferential surface (the inner wall surface) 2b of the valve housing 2. On the bottom surface side of the valve disk 4, one or a plurality (four in this example) of vent grooves (flow channels) 4c which are open on the outer circumferential surface 4b are formed. Preferably, the vent grooves 4c are provided in the valve disk 4 in at least two positions radially facing each other. However, the number of the vent grooves 4c is suitably set in accordance with application in which the check-relief valve 1 is applied. A penetration hole 4d is formed at the center of the valve disk 4. The check ball 3 comes into contact with an upper side opening edge portion of the penetration hole 4d, and the upper side opening edge portion of the penetration hole 4d functions as the sheet surface of the check ball 3. In addition, an outer circumferential edge portion on a lower surface 4e of the valve disk 4 is chamfered throughout the entire circumference and has a chamfered portion 4f.

In the inner circumferential surface 2b of the valve housing 2, as illustrated in FIG. 3, a step portion (regulation portion) 20 which extends in a direction of projecting radially inward from the inner circumferential surface 2b is formed. In this example, the step portion 20 is provided throughout the entire circumference of the inner circumferential surface 2b. The step portion 20 is formed at a borderline between the inner circumferential surface 2b and an inner circumferential surface 2c which is disposed below the inner circumferential surface 2b and has a diameter smaller than that of the inner circumferential surface 2b. The step portion 20 functions as a stopper which regulates a movement amount (retreat amount) of the valve disk 4 in a case where the valve disk 4 moves excessively downward.

In a lower side opening portion of the valve housing 2, as illustrated in FIG. 2, a flange portion 21 which protrudes radially inward from the inner circumferential surface 2c of the valve housing 2 and has an open hole 21a at the center is formed integrally with the valve housing 2. A lower end of the relief spring 6 comes into contact with the flange portion 21. The open hole 21a of the flange portion 21 communicates with the fluid introduction hole 101b of the tensioner housing 101 of the liquid pressure tensioner 100 (refer to FIG. 1). In addition, in a lower side outer circumferential portion of the valve housing 2, a boss portion 22 having a large diameter is formed. As illustrated in FIG. 1, the boss portion 22 is configured to be fixed to the bottom portion of the hole 101a of the tensioner housing 101 via a seal member 106.

Subsequently, an operational effect of the present exemplary embodiment will be described.

During an operation of the liquid pressure tensioner 100, the fluid from the external pressurized fluid source is introduced into the chamber 104 through the fluid introduction hole 101b of the tensioner housing 101, the chamber 104 is filled with the fluid, and outward pressing force with respect to the plunger 102 caused by liquid pressure applied by the fluid inside the chamber 104 and the urging force of the plunger spring 103 is balanced with the pressing force from the chain which comes into contact with the distal end portion 102a of the plunger 102.

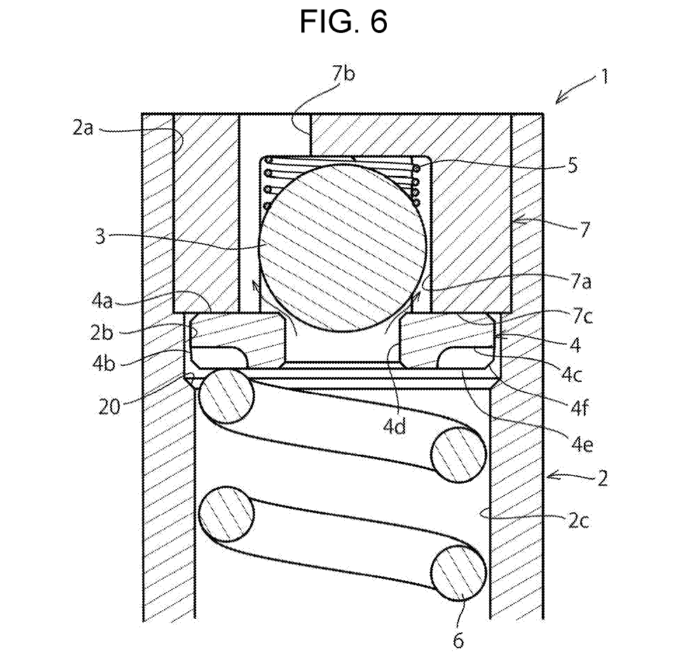

When the chain is stretched during an operation, the plunger 102 is lengthened (that is, moves in a projecting direction) and liquid pressure inside the chamber 104 is lowered. However, in this case, if the liquid pressure inside the chamber 104 becomes lower than a predetermined minimum pressure, the check ball 3 moves upward counteracting the spring force of the check spring 5. As a result thereof, a gap is formed between the check ball 3 and the valve disk 4, and thus, the check valve is opened (refer to FIG. 6). Accordingly, the fluid inside the valve housing 2 moves upward through the gap (refer to the arrow in FIG. 6), and the fluid is introduced into the chamber 104 through the penetration hole 7b of the retainer 7. Then, when the pressing force from the plunger 102 with respect to the chain applied by the resultant force of the liquid pressure inside the chamber 104 and the urging force of the plunger spring 103 is balanced with the pressing force from the chain counteracted by the plunger 102, the check ball 3 moves downward and comes into contact with the valve disk 4, and the check valve is closed.

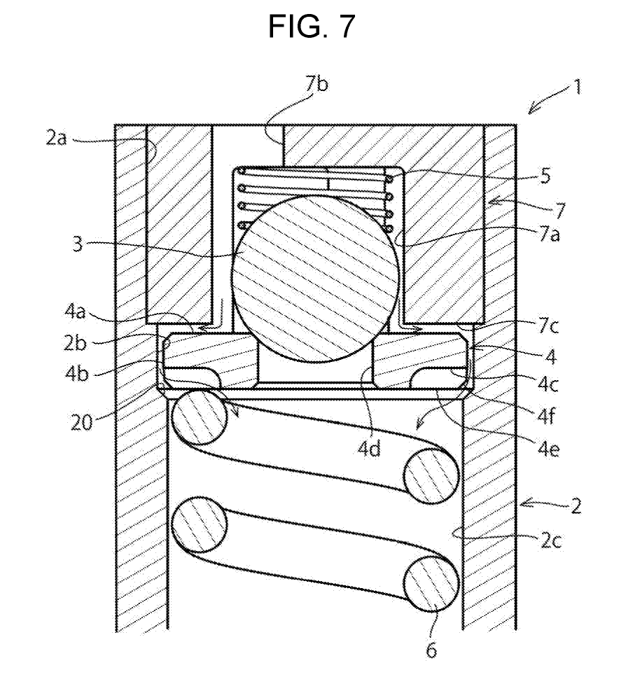

Meanwhile, during an operation, when pressing force from the chain counteracted by the plunger 102 is increased, the plunger 102 tends to move in a contraction direction (retreating direction) and the liquid pressure inside the chamber 104 increases. However, in this case, when the liquid pressure inside the chamber 104 exceeds a predetermined maximum pressure, the valve disk 4 moves downward (retreats) counteracting the spring force of the relief spring 6. As a result thereof, a gap is formed between the top surface 4a of the valve disk 4 and the lower surface 7c of the retainer 7, and thus, the relief valve is opened (refer to FIG. 7). Accordingly, the fluid inside the chamber 104 moves downward through the gap and the vent grooves 4c of the valve disk 4 via the penetration holes 7b of the retainer 7 (refer to the arrow in FIG. 7) and flows out through the open hole 21a of the lower side opening portion of the valve housing 2.

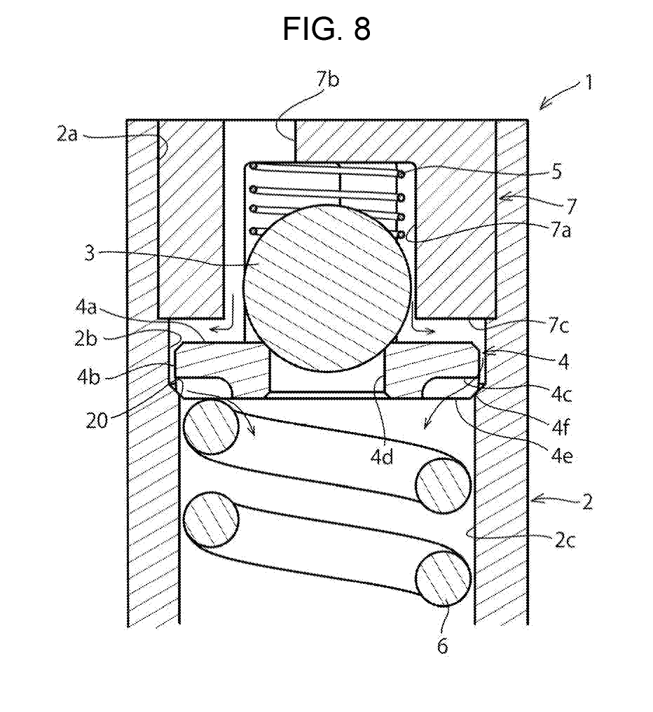

Subsequently, in a case where the liquid pressure inside the chamber 104 becomes higher, when a movement amount of the valve disk 4 reaches a predetermined movement amount, the chamfered portion 4f which is formed in the outer circumferential edge portion on the lower surface 4e of the valve disk 4 comes into contact with the step portion 20 of the inner circumferential surface 2b of the valve housing 2 from above (refer to FIG. 8). Accordingly, movement of the valve disk 4 is regulated. In this case, the gap between the top surface 4a of the valve disk 4 and the lower surface 7c of the retainer 7 is wider. Therefore, the quantity of the fluid flowing into the valve housing 2 through the gap increases.

In this manner, when the relief valve is in operation, before the retreat amount of the valve disk 4 becomes excessive, the retreat of the valve disk 4 is regulated. Therefore, it is possible to reliably prevent a possibility that the valve disk 4 tilts inside the valve housing 2 and becomes stuck or the check spring 5 exceeds the contraction state and is in a free length state. Moreover, in this case, the regulation portion is provided on the inner circumferential surface 2b so as to extend in a direction of projecting radially inward from the inner circumferential surface 2b of the valve housing 2. Therefore, it is possible to realize the integrated check-relief valve in a simple structure in which the retreat amount of the valve disk 4 can be regulated. In addition, since the regulation portion is configured to be formed of the step portion 20 which is formed on the inner circumferential surface 2 of the valve housing 2 and has a small diameter, the retreat amount of the valve disk 4 can be regulated in an extremely simple structure without adopting a separate member.

Hereinbefore, a favorable exemplary embodiment of the present invention has been described. However, application of the present invention is not limited thereto, and the present invention includes various modification examples. Hereinafter, several modification examples will be exemplified.

### First Modification Example

The above-described exemplary embodiment has presented an example in which the regulation portion regulating the retreat amount of the valve disk 4 is configured to be formed of the step portion 20 which is formed on the inner circumferential surface 2b of the valve housing 2 and has a small diameter. However, application of the present invention is not limited thereto.

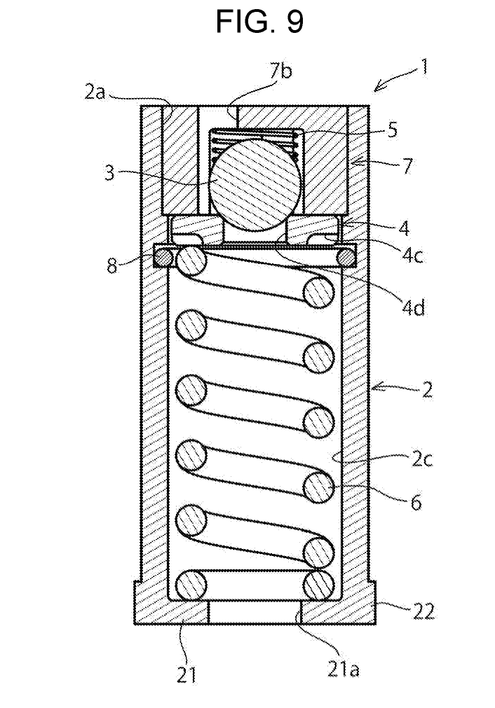

FIG. 9 to FIG. 11 illustrate the integrated check-relief valve of a first modification example of the present invention. In FIG. 9 to FIG. 11, the same reference numerals and signs as those in the above-described exemplary embodiment indicate the same or corresponding portions thereof.

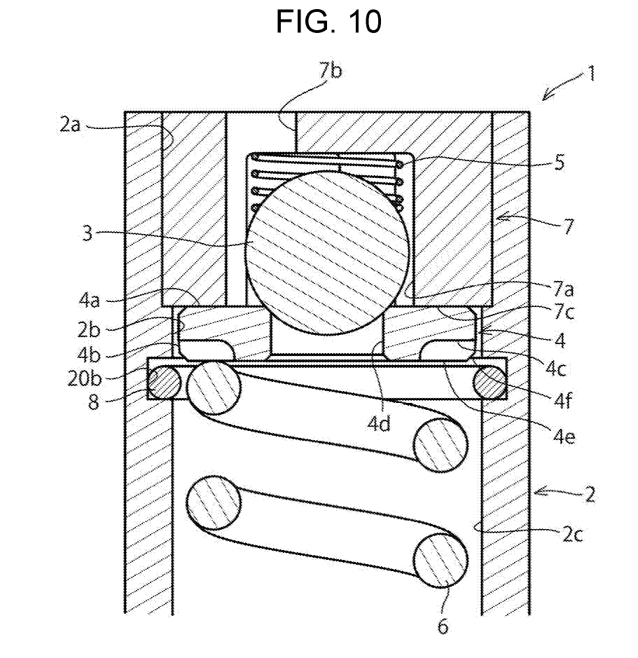

As illustrated in FIGS. 9 and 10, a circumference groove 20b is formed on the inner circumferential surface 2b of the valve housing 2, and a stopper ring 8 is mounted and held inside the circumference groove 20b. In this example, as the stopper ring 8, a ring having a cross-sectional circular shape is adopted. In addition, in this example, there is no step difference between the inner circumferential surfaces 2b and 2c of the valve housing 2, and an inner circumferential surface area below from the inner circumferential surface 2a forms a straight hole excluding the area of the circumference groove 20b.

During an operation of the liquid pressure tensioner 100, the operation performed when the check valve is opened due to lengthening of the plunger 102 is approximately similar to that in the above-described exemplary embodiment, and an operation performed when the relief valve is opened due to contraction of the plunger 102 is also similar to that in the above-described exemplary embodiment. However, when the relief valve is opened, the operation in a case where the movement amount of the valve disk 4 reaches a predetermined movement amount is different from that in the above-described exemplary embodiment.

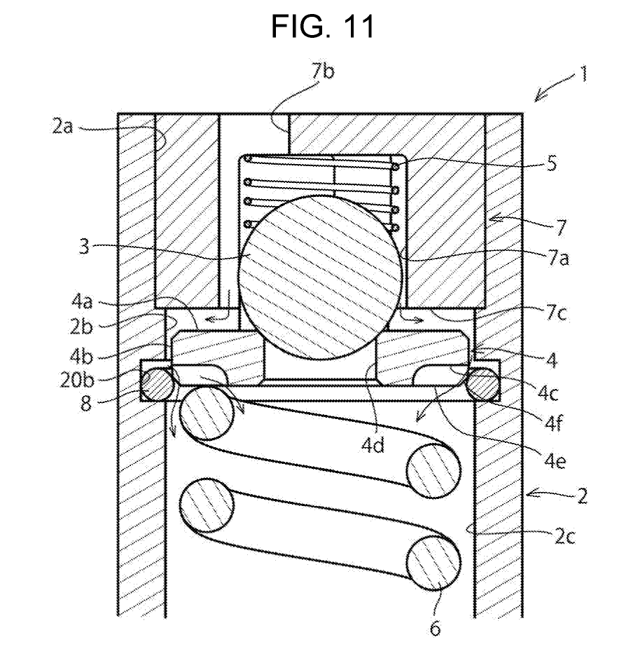

As illustrated in FIG. 11, when the movement amount of the valve disk 4 reaches a predetermined movement amount, the chamfered portion 4f which is formed in the outer circumferential edge portion on the lower surface 4e of the valve disk 4 comes into contact with the stopper ring 8 mounted in the circumference groove 20b on the inner circumferential surface 2b of the valve housing 2 from above. Accordingly, movement of the valve disk 4 is regulated. In this case, similar to the above-described exemplary embodiment, the gap between the top surface 4a of the valve disk 4 and the lower surface 7c of the retainer 7 is wider. Therefore, the quantity of the fluid flowing into the valve housing 2 through the gap increases.

In this manner, when the relief valve is in operation, similar to the above-described exemplary embodiment, before the retreat amount of the valve disk 4 becomes excessive, the retreat of the valve disk 4 can be regulated. Therefore, it is possible to reliably prevent a possibility that the valve disk 4 tilts inside the valve housing 2 and becomes stuck, or the check spring 5 exceeds the contraction state and is in a free length state. Moreover, in this case, a stopper ring on a market can be adopted. Therefore, it is possible to reduce the costs and to easily perform replacement at the time of maintenance.

### Second Modification Example

In the above-described exemplary embodiment, as an example of the valve housing 2, description has been given regarding a member which has the substantially cylindrical shape. However, other tubular shapes may be employed.

### Third Modification Example

In the above-described exemplary embodiment, as a preferable example of the valve member, the check ball 3 configured to be a solid ball is presented. However, the geometrical shape of the valve member is suitably determined in accordance with required response characteristics. For example, a hollow ball, a disk-shaped member, a tapered member, and the like may be employed.

### Fourth Modification Example

In the above-described exemplary embodiment, as an example of the valve seat member, description has been given regarding the disk-shaped valve disk 4. However, the shape of the valve seat member is not limited to that in the above-described exemplary embodiment, and various shapes can be employed. For example, the thickness of the valve seat member, the size of the open hole, the number and the depth of the flow channels, and the like can be suitably changed. In addition, the above-described exemplary embodiment has presented an example in which the outer circumferential edge portion of the valve disk 4 is chamfered and the chamfered portion 4f is brought into contact with the step portion 20 of the valve housing inner circumferential surface 2b. In this case, when a longitudinal sectional shape is viewed, the flat chamfered portion 4f of the outer circumferential edge portion of the valve disk 4 comes into contact with the flat step portion 20 on the valve housing inner circumferential surface 2b. However, any one or both the chamfered portion 4f and the step portion 20 may have a curved surface shape (curved convex surface or curved concave surface).

### Fifth Modification Example

As a preferable example of the valve housing 2, the above-described exemplary embodiment has presented an example in which the flange portion 21 protruding radially inward is formed integrally with the valve housing 2 in the lower side opening portion of the valve housing 2. However, application of the present invention is not limited thereto. A member corresponding to the flange portion 21 may be prepared as a separate member, and the separate member may be fixedly attached inside the lower side opening portion of the valve housing 2 by performing press-fitting or the like.

### Sixth Modification Example

In the fifth modification example, each of the members embedded inside the valve housing 2 can be inserted into the valve housing 2 from the lower side opening portion of the valve housing 2. However, in this case, the retainer 7 which is press-fitted in the upper side opening portion of the valve housing 2 may be formed integrally with the valve housing 2.

### Seventh Modification Example

The above-described exemplary embodiment has presented an example in which three open holes formed in the retainer 7 inside the valve housing 2 are disposed at equal intervals on the circumference. However, the number, disposition, the size, and the like of the open holes can be suitably changed.

### Eighth Modification Example

The above-described exemplary embodiment has presented an example in which the cross-section shape of the stopper ring 8 is a circle. However, the cross-section shape of the stopper ring is not limited thereto, and various shapes such as a rectangular shape, a trapezoidal shape, and the like can be employed. In a case where a polygonal shape such as a rectangular shape, a trapezoidal shape, and the like is employed, a corner portion on a side facing the valve disk 4 may be subjected to chamfering, and the chamfered portion 4f of the valve disk 4 may come into contact with the chamfered portion.

### Other Modification Examples

The exemplary embodiment and each of the modification examples described above have to be considered so as to be merely simple exemplification of the present invention in all aspects and are not limited. When those skilled in the art of the field relating to the present invention consider the above-described instruction, even though there is no specific disclosure in this specification, without departing from the gist and essential feature portions of the present invention, it is possible to establish various modification examples and other exemplary embodiments which employ the principle of the present invention.

### Alternative Application Example

In the above-described exemplary embodiment, description has been given regarding an example in which the integrated check-relief valve of the present invention is applied to a liquid pressure tensioner. However, the present invention can also be applied to other liquid pressure apparatuses (hydraulic apparatuses).

### INDUSTRIAL APPLICABILITY

The present invention is useful for an integrated check-relief valve, and is particularly suitable for an element in which a retreat amount of a valve seat member is required to be regulated when a relief valve is in operation.

1. An integrated check-relief valve comprising:
a tubular valve housing of which both ends are open;
a valve member axially moveable within the valve housing;
a valve seat member axially moveable within the valve housing and adjacent the valve member;
a check spring for urging the valve member towards the valve seat member; and
a relief spring for urging the valve seat member towards the valve member; and
a regulation portion on an inner wall surface of the valve housing projecting radially inward from the inner wall surface regulating an amount of movement of the valve seat member relative to the relief spring.

2. The integrated check-relief valve according to claim 1, wherein the regulation portion is a step portion having a small diameter formed on the inner wall surface of the valve housing.

3. The integrated check-relief valve according to claim 1, wherein the regulation portion is a stopper ring which is held on the inner wall surface of the valve housing.

4. The integrated check-relief valve according to claim 1, wherein the valve member is a check ball.

5. The integrated check-relief valve according to claim 1, further comprising one or a plurality of flow channels are formed on an outer circumferential surface of the valve seat member.

6. The integrated check-relief valve according to claim 5, wherein the flow channels are in at least two positions radially facing each other on the outer circumferential surface of the valve seat member.

7. The integrated check-relief valve according to claim 1, further comprising a flange portion which protrudes radially inward from the inner wall surface of the valve housing and has an open hole at a center is integrally formed with the valve housing in an opening portion of the valve housing on one end side, and one end of the relief spring comes into contact with the flange portion.

8. The integrated check-relief valve according to claim 1, further comprising a retainer received within an end of the valve housing which accommodates the valve member wherein the check spring is press-fit in an opening between the retainer and the valve member, and the valve seat member is urged by the relief spring to come into contact with the retainer.

9. (canceled)

10. A hydraulic tensioner comprising:
a tensioner housing that has a hole which is open in at least one end;
a plunger that is slidably accommodated in the hole and defines a chamber with respect to the hole; and
a plunger spring that is provided in the hole and urges the plunger in a direction of projecting from the hole;
an integrated check-relief valve received within the chamber comprising,
a tubular valve housing of which both ends are open;
a valve member axially moveable within the valve housing;
a valve seat member axially moveable within the valve housing and adjacent the valve member;
a check spring for urging the valve member towards the valve seat member; and
a relief spring for urging the valve seat member towards the valve member; and
a regulation portion on an inner wall surface of the valve housing projecting radially inward from the inner wall surface regulating an amount of movement of the valve seat member relative to the relief spring
wherein an opening portion of the valve housing on one end side communicates with a fluid introduction hole in the tensioner housing.

11. The hydraulic tensioner according to claim 10,
wherein when the plunger extends away from the tensioner housing and pressure of a fluid inside the chamber becomes lower than a predetermined minimum pressure, the valve member moves to a side where the check spring contracts so as to form a gap between the valve member and the valve seat member, and the fluid inside the valve housing is introduced to the inside of the chamber through the gap; and
wherein when the plunger is pushed towards the tensioner housing and the pressure of the fluid inside the chamber exceeds a predetermined maximum pressure, the valve seat member moves to a side where the relief spring contracts so as to form a gap on the periphery of the valve seat member and the fluid inside the chamber flows into the valve housing through the gap and flows out from the opening portion of the valve housing on the one end side, and if the pressure of the fluid inside the chamber becomes higher, additional movement of the valve seat member is regulated by the regulation portion.
